(19) United States
(12) Patent Application Publication
(10) Pub. No.: US 2018/0352125 A1
(43) Pub. Date: Dec. 6, 2018

(54) DEVICE WITH REPLACEABLE LENS MODULE

(71) Applicant: NATIONAL APPLIED RESEARCH LABORATORIES, Taipei City (TW)

(72) Inventors: Cheng-Fang HO, Hsinchu (TW); Wei-Yao HSU, Hsinchu (TW); Hau-Lin CHEN, Hsinchu (TW); Wen-Lung LIN, Hsinchu (TW); Zong-Ru YU, Hsinchu (TW); Wei-Jei PENG, Hsinchu (TW)

(21) Appl. No.: 15/867,561

(22) Filed: Jan. 10, 2018

(30) Foreign Application Priority Data
Jun. 6, 2017 (TW) 106118735

(51) Int. Cl. H04N 5/225; G03B 17/14; G02B 7/14

(52) U.S. Cl. CPC H04N 5/2254; G02B 7/14; G03B 17/14

(57) ABSTRACT

A device with a replaceable lens module is applied to an electronic device with a camera lens. The device includes a housing, a basic lens module and at least one functional lens module. The housing is configured for installing with the electronic device and has a hole corresponded to the camera lens. The basic lens module is connected to the housing and located corresponding to the hole. The functional lens module is detachably connected to the basic lens module. This configuration has the advantage of modularization design for providing two or more functions.

### CROSS REFERENCE TO RELATED APPLICATIONS

This Non-provisional application claims priority under 35 U.S.C. § 119(a) on Patent Application No(s). 106118735 filed in Taiwan, Republic of China on Jun. 6, 2017, the entire contents of which are hereby incorporated by reference.

### BACKGROUND

### Technology Field

The present disclosure relates to a device with a replaceable lens module, which is applied to a mobile device.

### Description of Related Art

The conventional mobile device with a camera function, such as the cell phone, tablet computer, and this likes, usually has a build-in lens module, and the focus of the lens module is generally adjusted by manual or software control. The build-in lens module cannot be replaced depending on different requirements, and the manufacturing cost thereof is higher.

Accordingly, the external optical device for changing the field of view or image filed size (e.g. external wide-angle lens, external fish-eye lens, or the likes) is provided. However, these external optical devices can only provide a single function. For example, the microscope device is applied to the macro photography only, and the telephoto device is applied to the telephoto photography only.

### SUMMARY

In view of the foregoing, an objective of the present disclosure is to provide a device with replaceable lens module that can provide two or more functions.

To achieve the above objective, the present disclosure provides a device with a replaceable lens module, which is applied to an electronic device with a camera lens. The device includes a housing, a basic lens module and at least one functional lens module. The housing is configured for installing with the electronic device and has a hole corresponding to the camera lens. The basic lens module is connected to the housing and located corresponding to the hole. The functional lens module is detachably connected to the basic lens module. This configuration has the advantage of modularization design for providing two or more functions.

In one embodiment, the housing includes an accommodating portion for receiving the electronic device and a handheld portion connecting to the accommodating portion, and the hole is located on the accommodating portion.

In one embodiment, a thickness of the handheld portion is equal to a height of the basic lens module. Accordingly, when the device is placed on a plane, the handheld portion and the basic lens module are both positioned on the plane for providing a supporting function, and thus the device can be kept balance on the plane.

In one embodiment, the handheld portion is detachable connected to the accommodating portion.

In one embodiment, the basic lens module is detachably screwed on the housing.

In one embodiment, the functional lens module is a telephoto lens, a wide-angle lens, or a microscope lens.

In addition, the present disclosure also provides a device with a replaceable lens module, which is applied to an electronic device with a camera lens. The device includes a housing and a basic lens module. The housing is configured for installing with the electronic device and has a hole corresponding to the camera lens. The basic lens module is detachably screwed to the housing and located corresponding to the hole.

As mentioned above, the device with a replaceable lens module of this disclosure has a modularization design, so that the single optical device can be removed or connected to provide two or more functions, such as the macro photography and telephoto photography, or the macro photography and wide-angle photography. Moreover, the device of this disclosure can be applied to other specific photography demands, such as the high magnification macro photography. In addition, when applying to the macro photography, the handheld portion and the basic lens module can firmly support the entire device, thereby easily and successfully finishing the focusing operation so as to obtain a clear image.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is an exploded view of a device with a replaceable lens module according to a first embodiment of the disclosure;

FIG. 2 is a side view of the device according to the first embodiment of the disclosure;

FIG. 3 is a schematic diagram showing another aspect of the device according to the first embodiment of the disclosure;

FIG. 4 is an exploded view of a device with a replaceable lens module according to a second embodiment of the disclosure; and

FIG. 5 is an assembled diagram of the device with a replaceable lens module according to the second embodiment of the disclosure.

### DESCRIPTION OF THE DISCLOSURE

The present disclosure will be apparent from the following detailed description, which proceeds with reference to the accompanying drawings, wherein the same references relate to the same elements.

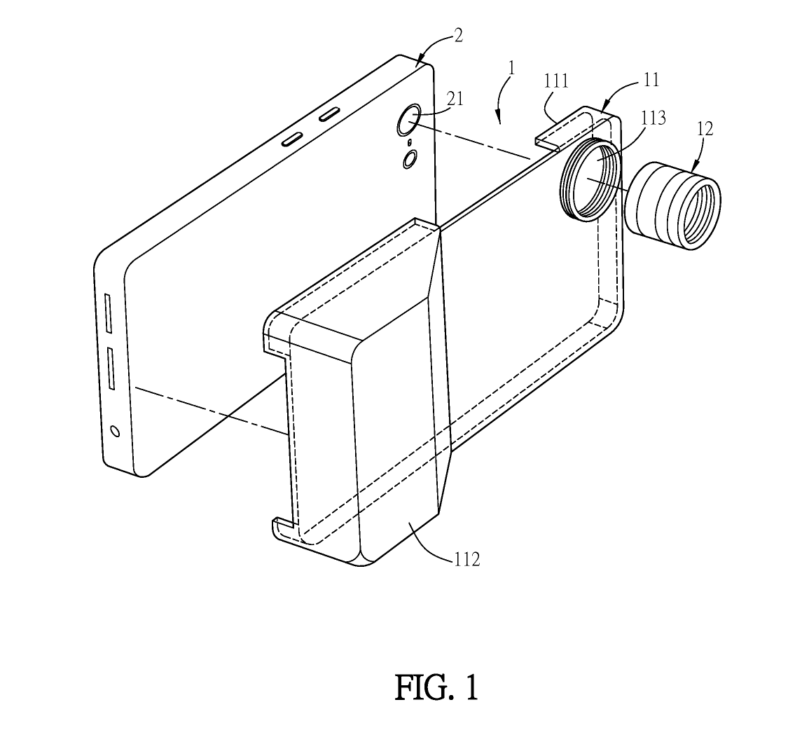

FIG. 1 is an exploded view of a device 1 with a replaceable lens module according to a first embodiment of the disclosure. In this embodiment, the device 1 is a phone case for installing an electronic device 2 (e.g. a cell phone or a tablet computer), and this disclosure is not limited. For example, the device 1 can also be a back cover of the cell phone or the tablet computer, or an accessory installed on the electronic device. The electronic device 2 includes a camera lens 21, and the device 1 includes a housing 11 and a basic lens module 12.

The housing 11 includes an accommodating portion 111, a handheld portion 112 connecting to the accommodating portion 111, and a hole 113 located on the accommodating portion 111. The hole 113 is located corresponding to the camera lens 21. The basic lens module 12 is detachably screwed on the accommodating portion 111 of the housing 11 and located corresponding to the hole 113. In this embodiment, the basic lens module 12 is a microscope lens. Accordingly, when the electronic device 2 is installed with the housing 11 of the device 1, the camera lens 21, the hole 113 of the housing 11 and the basic lens module 12 are disposed correspondingly (aligned), so that the electronic device 2 can be provided with a macro photography function for taking a photo of a close-up object in a fine or short distance. The user can hold the handheld portion 112 to operate the electronic device 2 when taking a photo. To be noted, the basic lens module 12 and the housing 11 can be connected by other means such as locking, integrally formation, or the likes, and this disclosure is not limited.

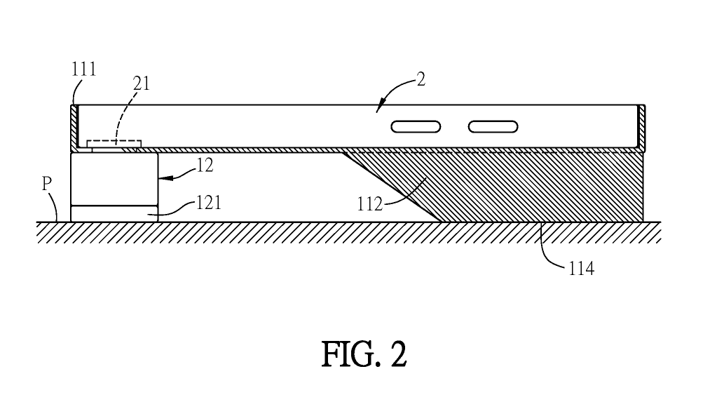

Reference to FIG. 2, the thickness of the handheld portion 112 is substantially equal to the height of the basic lens module 12. Accordingly, when the device 1 is placed on a plane P, an end portion 114 of the handheld portion 112 away from the accommodating portion 111 and the top portion 121 of the basic lens module 12 are both positioned on the plane P for providing a supporting function to support the device 1, and thus the device 1 can be kept balance on the plane P. Moreover, the electronic device 2 can directly perform a macro photography to an object placed on the plane P based on the focus setting of the basic lens module 12 (the thickness of the handheld portion 112 is the focus length of the basic lens module 12). This function can overcome the difficult of focusing in the situation of short depth of field in the macro photography so as to obtain a clear image.

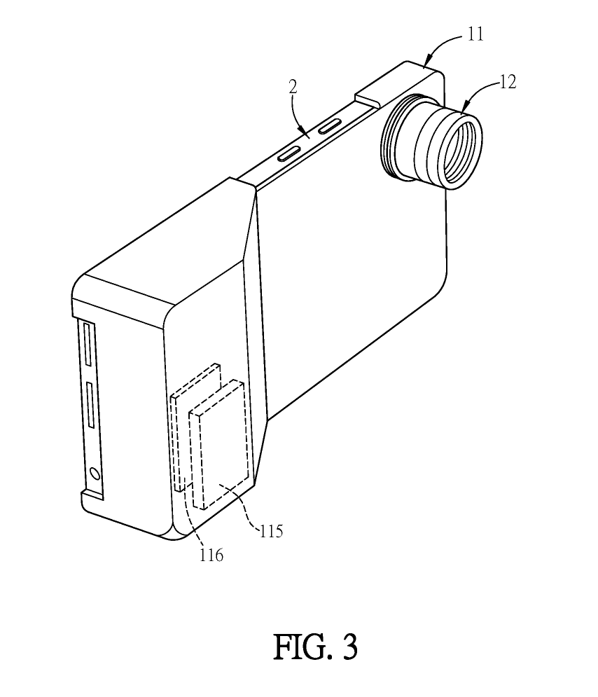

In addition, as shown in FIG. 3, the housing 11 may further include a power storage unit 115 disposed in the handheld portion 112 and a wireless circuit unit 116 electrically connected to the power storage unit 115. The power storage unit 115 is configured for storing electricity, and it can be a lithium battery, a NiMH battery, or the likes. The wireless circuit unit 116 can wirelessly communicate with the electronic device 2. Accordingly, when the electronic device 2 is installed on the housing 11 of the device 1, the power storage unit 115 can provide power to the electronic device 2 through the wireless circuit unit 116, so that the electronic device 2 can have longer operation time. In addition, the power storage unit 115 can be simply used as a backup power source, and this disclosure is not limited.

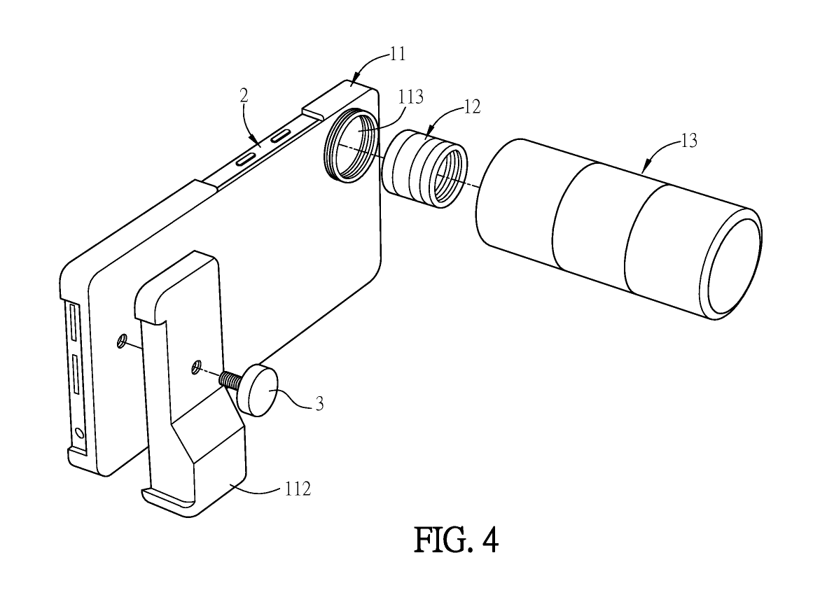

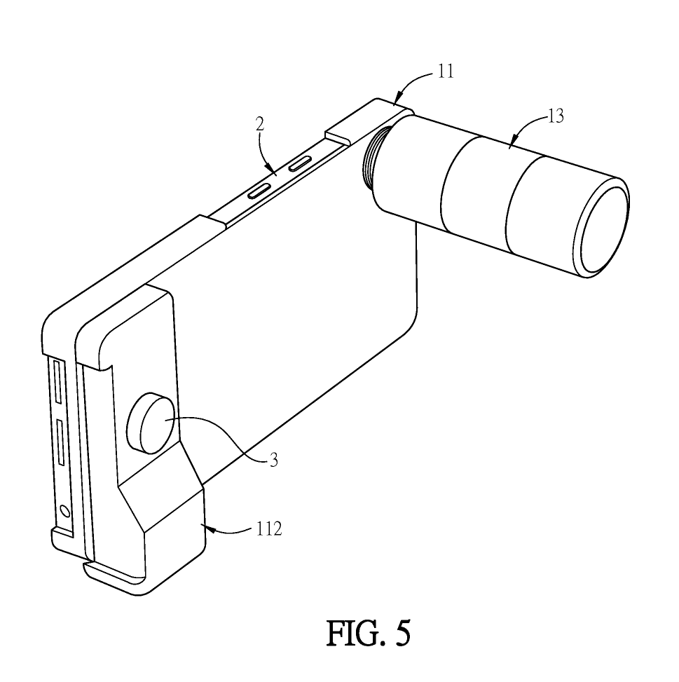

FIG. 4 is an exploded view of a device 1 with a replaceable lens module according to a second embodiment of the disclosure, and FIG. 5 is an assembled diagram of the device 1 according to the second embodiment of the disclosure. Different from the first embodiment, the handheld portion 112 of the second embodiment is detachably connected to the accommodating portion 111. In the second embodiment, the handheld portion 112 is screwed on the accommodating portion 111 by a screw 3, and this disclosure is not limited.

The device 1 further includes at least one functional lens module 13, which is detachably connected to the basic lens module 12. The functional lens module 13 can be optionally selected for providing the desired optical function of the electronic device 2 based on the demand of the user. For example, the functional lens module 13 can be a telephoto lens module, a wide-angle lens module, or a microscope lens module. In addition, the functional lens module 13 of this embodiment can be connected to the basic lens module 12 by screwing, so that the user can easily change the functional lens module 13 according to the requirement. For example, when the user wants to take a photo of a group of people, he/she can select a wide-angle lens module and screw the selected wide-angle lens module to the basic lens module 12 for taking a wide-angle photo. If the user wants to take a photo of a detail of an object or a microstructure object, he/she can select a microscope lens module and screw the selected microscope lens module to the basic lens module 12 for taking a high magnification photo. Accordingly, the user can have the option of two or more functions by selecting and installing the proper functional lens module 13, and the installation and uninstallation of the functional lens module 13 are very simple and convenient.

To be noted, the number of the functional lens modules 13 can be modified based on the requirement, and the handheld portion 112 may have a hollow design for accommodating the removed functional lens module 13. For example, the uninstalled functional lens module 13 can be locked or screwed in the handheld portion 112, so that it can be easily carried.

In summary, the device 1 with a replaceable lens module of this disclosure has a modularization design, so that the single optical device can be removed or connected to provide two or more functions, such as the macro photography and telephoto photography, or the macro photography and wide-angle photography. Moreover, the device of this disclosure can be applied to other specific photography demands, such as the high magnification macro photography. In addition, when applying to the macrophotography, the handheld portion 112 and the basic lens module 12 can firmly support the entire device, thereby easily and successfully finishing the focusing operation so as to obtain a clear image.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

1. A device with a replaceable lens module, which is applied to an electronic device with a camera lens, comprising:
a housing configured for installing with the electronic device and having a hole corresponding to the camera lens;
a basic lens module connected to the housing and located corresponding to the hole; and
at least one functional lens module detachably connected to the basic lens module;
wherein the housing comprises an accommodating portion for receiving the electronic device and a handheld portion connecting to the accommodating portion, the hole is located on the accommodating portion, and the handheld portion is detachably connected to the accommodating portion.

2. (canceled)

3. (canceled)

4. (canceled)

5. The device of claim 1, wherein the basic lens module is detachably screwed on the housing.

6. The device of claim 1, wherein the basic lens module and the housing are integrally formed as one piece.

7. The device of claim 1, wherein the functional lens module is detachably screwed on the basic lens module.

8. The device of claim 1, wherein the functional lens module is a telephoto lens, a wide-angle lens, or a microscope lens.

9. A device with a replaceable lens module, which is applied to an electronic device with a camera lens, comprising:
a housing configured for installing with the electronic device and having a hole corresponding to the camera lens; and
a basic lens module detachably screwed to the housing and located corresponding to the hole; and
at least one functional lens module detachably connected to the basic lens module;
wherein the housing comprises an accommodating portion for receiving the electronic device and a handheld portion connecting to the accommodating portion, the hole is located on the accommodating portion, and a thickness of the handheld portion is equal to a height of the basic lens module.
